(19) United States
(12) Patent Application Publication
(10) Pub. No.: US 2022/0140668 A1
(43) Pub. Date: May 5, 2022

(54) Electric Machine and Method for Manufacture

(71) Applicant: ABB Schweiz AG, Baden (CH)

(72) Inventors: Colin Tschida, Durham, NC (US); Graham L. Medlin, Durham, NC (US); Md Ashfanoor Kabir, Apex, NC (US)

(73) Assignee: ABB Schweiz AG, Baden (CH)

(21) Appl. No.: 17/088,698

(22) Filed: Nov. 4, 2020

(51) Int. Cl. H02K 1/18; H02K 1/16; H02K 1/26; H02K 1/28; H02K 15/02

(52) U.S. Cl. CPC H02K 1/185; H02K 1/16; H02K 15/024; H02K 1/28; H02K 1/26

(57) ABSTRACT

An electric machine includes a core comprising a plurality of core segments extending in a longitudinal direction and a plurality of slots being equally spaced peripherally around the core and formed between cutouts in adjacent segments. A plurality of windings is disposed on the core and includes straight portions disposed in the plurality of slots and turn portions extending past at least one axial end of the core along the longitudinal direction. The core and windings are assembled together in an unrolled condition, where the mat is placed in an unrolled core, and then rolled together to form a stator or rotor.

### BACKGROUND OF THE INVENTION

Use of electric vehicles such as cars, trucks, trains and the like has been and continues to be increasingly popular due to the performance characteristics and low to no harmful emissions emitted by these vehicles. One type of electric car uses batteries carried onboard the vehicle to power electric motors. Other types of vehicles include hybrid drive systems, or receive electrical power from an external source such as overhead power lines. To be competitive in the electric vehicle market, original equipment manufacturers (OEM) of such vehicles constantly strive to develop electric-traction motors that are increasingly compact, light, and perform at a higher efficiency than their predecessors.

One type of motor that is increasingly used in electric vehicles includes a so-called hairpin winding for the motor's stator conductors. This winding configuration is amenable to automated winding process, but the large size of the conductors is prone to proximity losses resulting in high winding AC losses. Moreover, these motors are more difficult and complex to manufacture. Previously proposed solution to address these challenges, for example, motors using plug-in windings, in which coils are pre-made with plug-in features (male-female), are easier to manufacture but have high contact resistivity in the plug-in connectors, which can result in thermal hot spots.

Examples of previously proposed solutions for improving the performance while reducing manufacturing costs for electric motors having hairpin winding stators can be seen in Italian Patent Application No. 2017 00151114 to Ranalli et al. (Ranalli), and in U.S. Patent Application Pub. No. 2017/0317676 A to Hatch et al. (Hatch).

Ranalli describes a process for making a continuous bar winding for an electric machine in which a template is used that includes a circular array of slots having open faces. A conductive bar is inserted into the slots and shaped so that it passes through the slots to form a plurality of bar portions and a plurality of connecting portions projecting beyond the open end faces of the template.

Hatch describes using a composite elbow to form a continuous winding from a conductor having a rectangular cross section. The conductor is bent into shape at the composite elbows so as not to disturb the insulation surrounding the conductor.

While these solutions may improve the manufacturability of motors, the manufacturing process remains complex and intensive without providing appreciable cost savings in that the process still requires inserting hairpin windings into stator slots and welding or otherwise connecting conductor portions to one another.

### BRIEF SUMMARY OF THE INVENTION

In one aspect, the present disclosure describes an electric machine. The electric machine includes a core having a generally cylindrical shape extending along a longitudinal direction, the core comprising a plurality of core segments extending in the longitudinal direction. The core further includes a plurality of slots extending along the longitudinal direction and being equally spaced peripherally around the core, each of the plurality of slots formed between cutouts in adjacent segments. A plurality of windings is disposed on the core, the plurality of windings including straight portions disposed in the plurality of slots and turn portions extending past at least one axial end of the core along the longitudinal direction. A fastening arrangement is disposed around an outer periphery of the core, the fastening arrangement securing the plurality of the core segments to one another.

In another aspect, the present disclosure describes a method for constructing an electric machine. The method includes providing an unrolled core, the unrolled core comprising a plurality of core segments arranged adjacent to one another on a generally flat surface in an unrolled condition, wherein each of the plurality of core segments has a generally triangular shape, and more specifically a trapezoidal shape or a truncated triangular shape, such that wedge-shaped openings are formed between adjacent core segments and a central bore remains, for example, when a stator is made. The method further includes, providing a mat of woven conductors, the mat comprising a plurality of bent conductors, each having a straight portion and bent portions at either end of the straight portion. The mat is placed in engaging relation with the unrolled core such that the straight portions of the plurality of bent conductors are disposed in the wedge-shaped openings and the bent portions extend on either side of the unrolled core, the mat and unrolled core defining an unrolled assembly. The unrolled assembly is rolled into a generally cylindrical component and secured in a rolled condition such that the straight portions of the conductors are disposed in longitudinal slots formed between adjacent core segments.

In yet another aspect, the disclosure describes a stator for a motor. The stator includes a core having a generally cylindrical shape extending along a longitudinal direction, the core comprising a plurality of core segments extending in the longitudinal direction, wherein each of the plurality of core segments is generally triangular and extends over a portion of a periphery of the core, each core segment having a base, a rib connected to the base and having at least one cutout, and an inner wall connected to the rib opposite the base. The bases of the plurality of core segments collectively define an outer cylindrical portion of the core, the inner walls of the plurality of core segments collectively define an inner rotor bore of the core, and each cutout at least partially defines one of a plurality of slots extending along the longitudinal direction and being equally spaced peripherally around the core. A plurality of windings is disposed on the core and includes straight portions disposed in the plurality of slots and turn portions extending past at least one axial end of the core along the longitudinal direction. A fastening arrangement secures the plurality of the core segments to one another.

### BRIEF DESCRIPTION OF THE SEVERAL VIEWS OF THE DRAWING(S)

FIG. 1 is a schematic view of an electric machine in accordance with the disclosure.

FIG. 2 is an illustration of a winding mat in accordance with the disclosure;

FIG. 3 is an illustration of an expanded core in accordance with the disclosure.

FIG. 4 is an illustration of the winding mat of FIG. 2 installed onto the expanded core of FIG. 3 during a manufacturing process step in accordance with the disclosure.

FIG. 5 is an illustration of the expanded core with winding mat installed in a partially rolled state in accordance with the disclosure.

FIG. 6 is an enlarged, partial view of a stator during a rolling operation in accordance with the disclosure.

FIG. 7 is an exemplary outline view of a rotor, and FIG. 8 is an exemplary outline view of a stator in accordance with the disclosure.

FIG. 9 is a flowchart for a method in accordance with the disclosure.

### DETAILED DESCRIPTION OF THE INVENTION

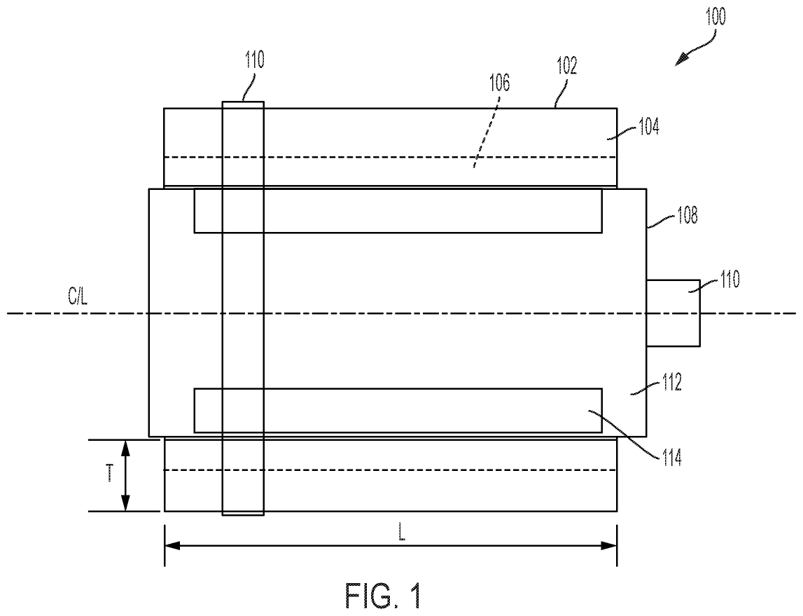

The present disclosure is applicable to electric machines and, more particularly, dynamoelectric machines such as those used in automotive and other applications, for example, alternators, alternator-starters, traction motors, and others. The disclosed systems and methods are particularly well suited for constructing dynamoelectric machines such as those used on heavy electric vehicles such as hybrid electric vehicles, direct electric vehicles such as rail applications utilizing an overhead power line or a third rail, plug-in hybrid electric vehicles (PHEVs), hydrogen-fuel cell electric vehicles (FCEVs), and others. A schematic diagram of an electric machine for use with such vehicles is shown in FIG. 1, but it should also be appreciated that the electric machine shown in FIG. 1 can also be used other stationary or mobile industrial and marine applications to convert electrical to mechanical power. The electric machine 100 includes a stator 102, which includes a cylindrical core 104 formed as a stack of individual laminations and having a number of circumferentially spaced slots 106 that extend axially through the stator core 104. In the exemplary embodiment illustrates, a rotor assembly 108 includes a center shaft 110 extending through a rotor core 112, which includes rotor windings 114. Alternative rotor designs may include permanent magnets and/or flux barriers. The rotor assembly 108 is coaxial with the stator core 102. The stator core typically includes wires wound thereon in the form of windings that extend axially through the core slots. End turns are formed in the windings or conductors at both axial ends of the stator such that any given winding has one end loop as it turns when exiting one stator slot before entering an adjacent slot. In this general manner, a stator winding extends axially from end to end in selected core slots and also and extends at least partially circumferentially between slots of the stator core according to a chosen wiring pattern.

A stator may be formed with any number of separate phase windings, such as three-phase, five-phase, six-phase, etc., and such determines the general wiring pattern to be implemented when winding the stator core. Since most applications emphasize reducing the size of the electric machine while improving efficiency, it is desirable to utilize the available slots in a manner that maximizes the filling of the stator core slots. High slot fill stators generally produce more electrical power with increased machine efficiency. Use of rectangular conductor wire rather than round wire may achieve a higher fill ratio.

Typical hairpin conductors in use prior to the present invention were U-shaped solid wires having a substantially rectangular cross-sectional profile, which were inserted from one end of the stator into two slots and are then twisted and welded to other hairpins at the other axial end of the stator core to form a phase winding. Moreover, the typical hairpin conductors may require a tradeoff between achieving a high slot fill ratio and reducing undesirable AC performance characteristics such as skin effect and others. Skin effect reduces the effective cross-sectional area of a conductor in a slot as the thickness of the conductor increases. Therefore, generally, the thickness of rectangular wires in a slot should be made as small as possible. Alternatively, a given wiring configuration may be designed to greatly reduce undesirable performance, for example by placing more than one phase in a slot.

The present disclosure advantageously eliminates the need to perform the numerous welds that are required to assemble a complete stator (or rotor) core, and further provides direct access within semi-closed slots, rather than the typical open slots, during assembly to improve the assembly process and avoid expensive and complex assembly tooling. As compared to typical continuous winding processes, the systems and methods disclosed herein advantageously maintains slot wedges, which helps minimize slot harmonics and associated losses during operation of the motor. In general, the present disclosure describes a system and method for assembling stators (or rotors) using a roll-up style core having a winding mat assembled therein. In the disclosure that follows, a stator is used as an example to illustrate the systems and methods but it should be appreciated that the systems and methods are applicable to other electric machines. The stator described herein is an example that is common for tooth-wound style machines.

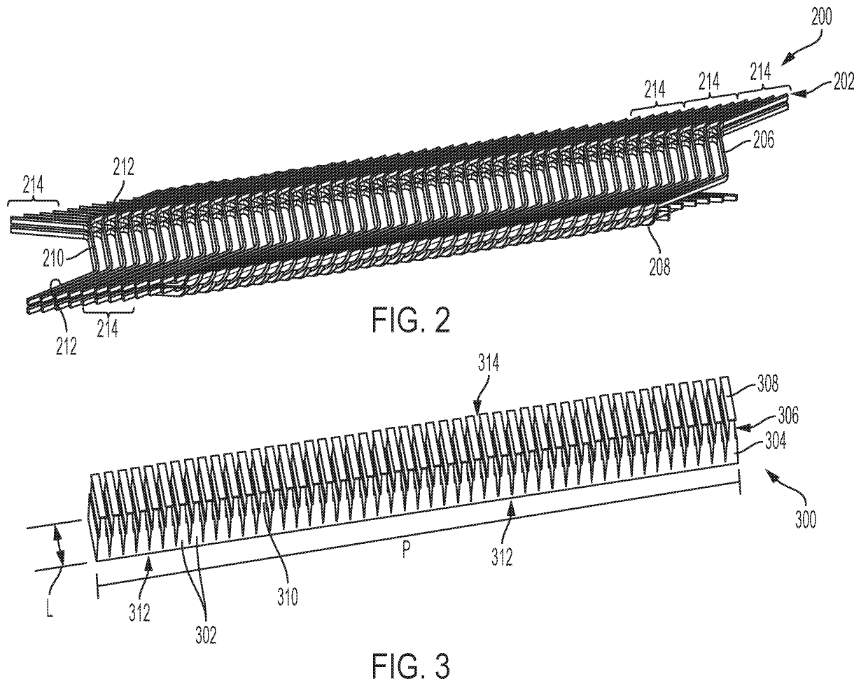

From a broad perspective, a stator in accordance with the disclosure is produced as an assembled strip and the continuous hairpin is produced as a winding mat. Outline views of a winding mat 200 is shown in FIG. 2, and an expanded core 300 is shown in FIG. 3. In reference to these figures, it can be seen that the mat 200 is made up from an arrangement of a plurality of shaped conductors 202, each of which has two or more “S” pre-bent sections 206 (in the illustrated embodiment, 4 sections) that are connected to one another using turns 208. The sections 206 are stacked over one another to form four layers, but it should be appreciated that any number of layers can be used. Moreover, the number of conductors 202 can be separated into groups, for example, phases, and include as many stacks as there are slots to fill in the stator. As shown, each section 206 includes a straight portion 210, which is straight, and two bent portions 212 that extend at complementary angles from either free end of the straight portion 210. In the illustrated embodiment, the bent portions 212 are generally parallel to one another but it should be appreciated that any other angle can be used. Moreover, as shown, the sections 206 are arranged in groups 214 of four, to occupy four slots each, one group per phase, and there are a total of 12 groups for a total of 48 slots, distributed among three phases. While one configuration is shown as an example, it should be appreciated that other configurations can also be used. For example, a fractional slot configuration may be used in which each slot contains conductors from more than one phase. Such alternative configurations can be easily achieved without adding cost or complexity to the manufactured device by simply arranging the conductors in the mat 200 in any desired configuration before insertion into an expanded core as described below.

An outline view of an exemplary expanded core 300 is shown in FIG. 3. The expanded core 300 is constructed by a plurality of core sections 302. The core sections 302 have a generally triangular or, as shown, trapezoidal shape. For purpose of assembling the sections 302 into a cylindrical shape, when forming a rotor, or a hollow cylindrical or tubular shape, when forming a stator, each core section 302 has a truncated triangular or trapezoidal shape. As can be appreciated, when forming a rotor, the shape of the sections 302 may leave a central opening to accommodate the shaft of the motor. Alternatively, when forming a stator, the assembled core sections may leave a central bore to accommodate the rotor. Each core section 302 has a flat, segmented shape that includes a base 304, a slot cutout 306 connected to and adjacent to the base 304, and an inner wall 308. Each core section 302 has a length, L, in an axial direction along a centerline (C/L) which coincides with a rotation axis of the rotor assembly 108 when the electric machine 100 is assembled (see FIG. 1). The length L coincides with the axial length of the stator 102, or at least a portion thereof. Each core section 302 further has a height, T, which coincides with the radial thickness of the stator, T (FIG. 1), when the electric machine 100 is assembled. The aggregate dimension of the bases 304 of the plurality of core sections 302, P (FIG. 3), coincides with the outer periphery of the stator 102 and, similarly, a total length of the inner walls 308 together forms an inner periphery of the stator 102 when the electric machine 100 is assembled.

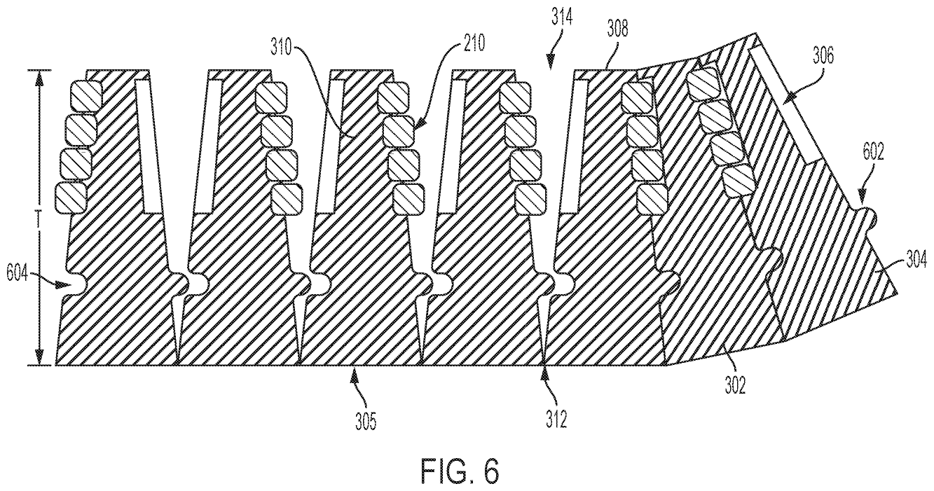

Each core section 302 further forms cutouts or, in general, one or more depressed areas along the P direction (FIG. 3) into which conductors are accommodated. When the expanded core 300 is rolled into a cylinder to form the stator 102, the inner walls 308 come together such that the slot cutouts 306 from two adjacent core sections 302 form a stator slot 106 (FIG. 1). Features in the cutouts 306 can be shaped to accommodate the shape of the conductor that is inserted, that is, the conductor cross sectional shape that is used to make the mat 200. In the embodiment shown, the conductors have a generally rectangular cross section and thus the cutouts 306 have a generally rectangular shape. A depth of each cutout 306 is selected to cover half the width of the conductors such that each resulting slot 106 accommodates a stack of conductors (see FIG. 6), but other dimensions may be used depending on the number, arrangement and shape of the conductors that will be inserted into the core. The cutout 306 in each core section 302 extends between an outer side of the inner wall 308 and an inner end of the base 304 around a rib 310, which extends generally along the direction of the height T and forms a separating section between adjacent slots 106 extending in radial direction in the finished core 102.

The number of core sections 302 depends on the number of slots that the core 102 will have. In the illustrated embodiment, the core 102 includes 48 slots 106 and, thus, 48 core sections 302 are used and are all identical and symmetrically distributed around the finished core 102. The core sections 302 are made from core material, for example, a metal, and can be formed into a desired shape by an appropriate process, for example, forging, extruding or machining section bars that are cut to the desired length, drop forging, sintering, molding of composite materials, and the like. In the illustrated embodiments, the core sections 302 are formed by metal laminations that are punched out of a metal plate at the desired shape and are stacked to form the finished core section 302. Depending on the plate thickness used to make the punched out plates, an appropriate number of plates is stacked to build a stack having the desired length, L. Also in the illustrated embodiment, the sections are punched out together in groups of 48 in strips having an overall length P. In this embodiment, a small amount of material is left at the connection points 312 between adjacent core sections 302 to serve as a connection point and also a pivot allowing the various core sections 302 to come together into a cylindrical structure when the core is rolled into its final shape.

The yielding material at the connection points 312 provides alignment to the various core sections 302 during rolling, but other methods of attaching the sections such as pins can also be used, or the sections can also be made as separate structures and attached to a pliable material, such as an adhesive strip, for assembly. The finished core 102 can be secured into its cylindrical shape by the same method, by use of clamps, straps and/or any other appropriate fastening arrangement. As shown in FIG. 1, bundling straps 116 made of a metal such as stainless steel are used to bundle the sections together. Moreover, other alignment features such as teeth 602 and grooves 604 can be used to align the sections together, as shown in FIG. 6.

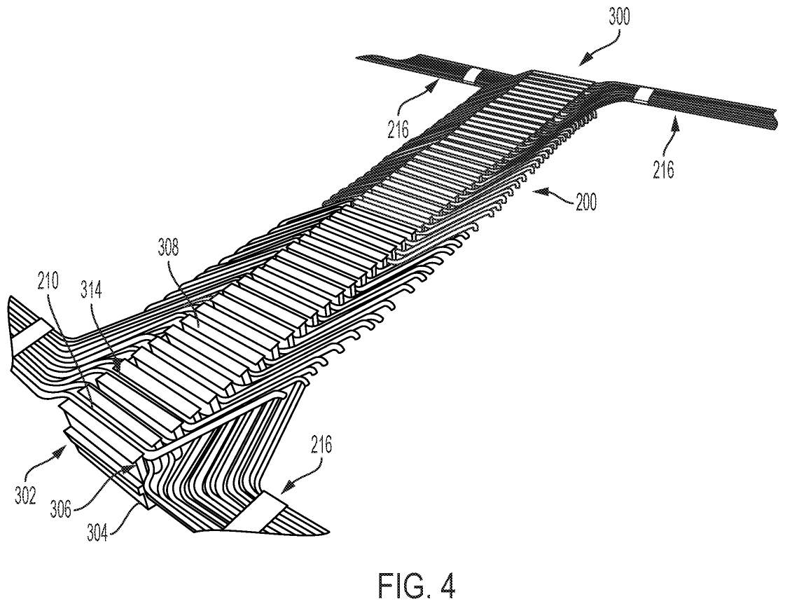

Typically, for a continuous hairpin machine, the winding mat is inserted, assembled or fabricated into a round stator and expanded into the slots. Instead of following the typical process, which is complex and requires expensive equipment, the present disclosure involves weaving the mat 200 on an open surface and dropping the pre-assembled mat 200 dropped into an also-open, un-rolled stator or expanded core 300, as shown in FIG. 4. During such placement of the mat 200 onto the expanded core 300, the straight portions 210 of the conductors are aligned and placed into an open, wedge-shaped space 314 through a slot or opening that remains between two adjacent inner walls 308 when the expanded core 300 is in the unrolled condition as shown in FIGS. 3 and 4.

More particularly, when the mat 200 in its unrolled condition is placed, dropped or otherwise engaged with the expanded core 300, the straight portions 210 are aligned and disposed within the corresponding wedge-shaped spaces 314 of the expanded core 300 at a height where a stack of straight portions 210 is disposed within or adjacent and in alignment with the cutouts 306. In this position, shown in FIG. 4, the bent sections 206 extend on either side of the expanded core at an angle such that, when the core 300 is rolled into the rolled condition, the bent sections create the turns at either axial end of the core 102.

In the embodiment shown in FIG. 4, the conductors 202 that make up the mat 200 are formed with additional portions 216 such that their ends extend to the two axial ends (along P, FIG. 3) to meet when the core 102 is in its rolled condition to facilitate the electrical connections of the multiple phases and groups of conductors together and to further reduce the number of connections or welds, and also the final assembly of the electric machine 100.

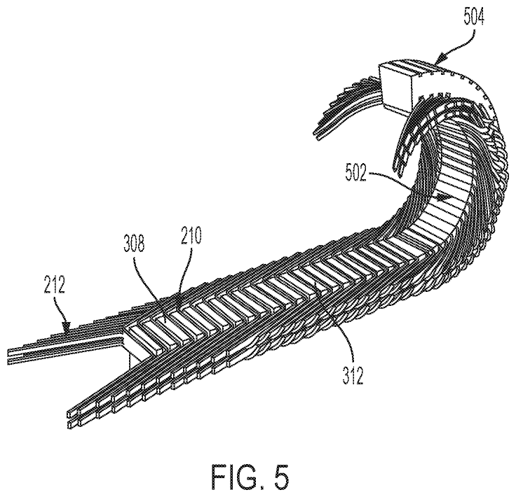

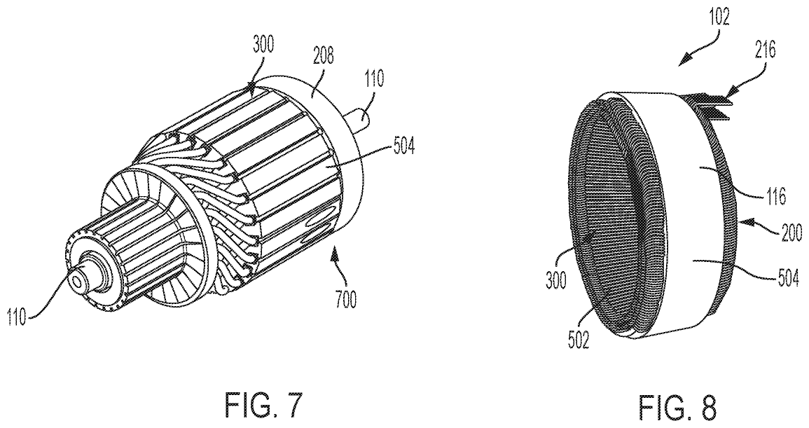

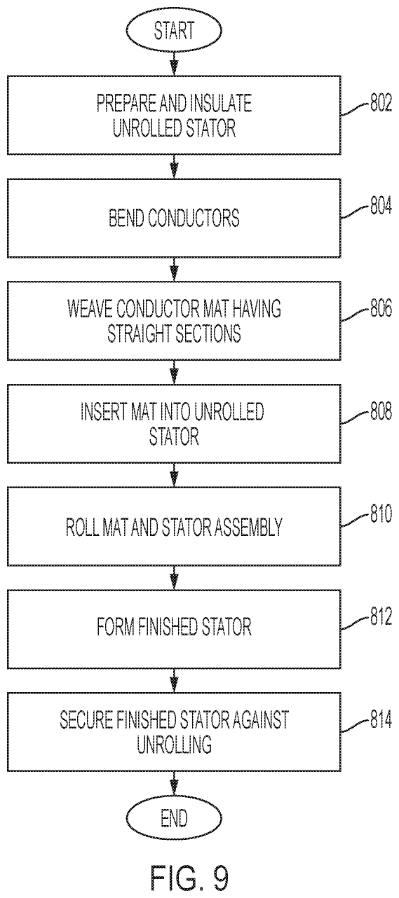

Following placement of the mat 200 into the expanded core 300, the combined structure is rolled from one or both ends to form a circular shape such as a cylinder, as shown in FIG. 5, and the enlarged, detail view of FIG. 6, which illustrate the combined mat 200 and core 300 in a partially rolled state from one end. As can be seen, the inner walls 308 touch and outer walls 305 of the bases 304 combine to, together, define an inner cylindrical surface 502 and an outer cylindrical surface 504 of the cylindrical stator 102. The combined structure is rolled until a full cylinder, which is now the stator 102, is formed, as shown in FIG. 8. Alternatively, the combined structure can be rolled around a shaft, for example, the shaft 110 (FIG. 1) to form a rotor 700, rather than the stator 102, as shown in FIG. 7.

One possible area of improvement that can be accomplished when constructing a stator, rotor or other component(s) of an electric machine using the rolling process and structures described herein is to minimize any effects of the numerous air gaps to the flux path within the completed stator or rotor. Roll-up machines are usually restricted to high-pole count tooth-wound products where this effect is less pronounced. The impact of the air gaps can be estimated by considering that the flux will pass through Q/p cuts in the iron, where Q is the number of slots and P is the number of poles, and each cut has a thickness oft which contributes a reluctance proportional to t/μsLs where s is the path length of the “cut” in the iron, and Lsis the stack length. Thus, we are adding an effective air gap of Qt/μsLsp and it can be observed that the proposed method offers better performance for a higher pole count, longer cut length, and smaller t. In addition, there is less of a penalty for permanent magnet (PM) machines where the effective air gap is already large due to the presence of the magnets.

A tabulated set of exemplary parameters for typical motor configurations and its impact on path reluctance is provided in Table 1 below for some representative values of thicknesses t that can be easily manufactured:

TABLE 1
Impact on Path Reluctance

| Q | P | t [mm] | % increase |
|---|---|---|---|
| 72 | 4 | 0.01 | 2% |
| 72 | 4 | 0.05 | 9% |
| 72 | 8 | 0.05 | 5% |
| 72 | 8 | 0.01 | 1% |

As a specific example, consider a motor for traction applications with 72 slots, 4/8 poles, an air gap of 0.8 mm, with 5.6 mm thick magnets that are 20 mm wide. The stack length is 300 mm, and the rotor OD is 168 mm and the stator OD is 230 mm. Table 1 summarizes the impact on the effective air gap reluctance added by the cuts in the back iron. Assuming that s=17.4 mm, then the total path reluctance, Rₜₒₜ, can be calculated by Equation 1:

$${R}_{t o t} = \frac{Q}{P} {R}_{c u t s} + 2 {R}_{m a g n e t} + {R}_{g a p} = \frac{1}{μ {L}_{s}} [ \frac{Q t}{sp} + \frac{2 {t}_{m a g}}{{w}_{m a g}} + \frac{p {t}_{g a p}}{π {r}_{g a p}^{2}} ] \qquad Equation 1$$

It can be appreciated from this example that the impact from the cuts in the back-iron is not necessarily large, but is heavily dependent on accuracy of the closure, t. Note that doubling the path length of the cut, s, has the effect of halving the additional reluctance.

A flowchart for a method of producing a rolled electrical machine component, for example, a stator, in accordance with the present disclosure is shown in FIG. 8. In no particular order, the method includes preparing and insulating an unrolled or expanded stator at 802. The preparation of the stator at 802 may include stamping, molding, machining or otherwise preparing one or more stator segments that are either connected to one another at their respective bases in groups, sub-groups, for example, to form a quadrant, or other arrangement. Further, the sections or segments of the stator may be formed as loose, separate pieces that are then connected to one another adjacently on a flexible substrate such as an adhesive or magnetic strip. A plurality of conductors is bent at 804 and the bent conductors are woven together using welding at appropriate connection points to form an unrolled mat at 806. As described above, the mat may include straight and bent sections, the straight sections forming a ladder structure having parallel groups conductor straight sections that will occupy slots in the finished stator.

The mat is inserted into the expanded stator at 808 such that the straight, parallel sections occupy wedge shaped or V-shaped openings and are aligned with slot cutouts in the expanded stator sections. The mat and expanded stator assembly is rolled at 810 to form the finished stator at 812, and the rolled structure is strapped or otherwise secured against unrolling at 814. In the embodiments described earlier in this disclosure, the stator sections were shown having flat bases such that the resulting structure for the stator has a generally polygonal exterior profile, but as can be appreciated any other appropriate shape may be used. For example, the base faces of the sections can be curved at the radius of the finished stator, and also the internal faces, to produce a perfectly cylindrical structure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An electric machine, comprising:
a core having a generally cylindrical shape extending along a longitudinal direction, the core comprising a plurality of core segments extending in the longitudinal direction;
the core further including a plurality of slots extending along the longitudinal direction and being equally spaced peripherally around the core, each of the plurality of slots formed between cutouts in adjacent segments;
a plurality of windings disposed on the core, the plurality of windings including straight portions disposed in the plurality of slots and turn portions extending past at least one axial end of the core along the longitudinal direction; and
a fastening arrangement disposed around an outer periphery of the core, the fastening arrangement securing the plurality of the core segments to one another.

2. The electric machine of claim 1, wherein the plurality of windings comprises two or more groupings of conductors, each grouping of conductors formed by a pre-bent portions assembled to one another in a mat configuration.

3. The electric machine of claim 1, wherein each of the plurality of core segments has a generally triangular shape that includes a base, a rib disposed adjacent the base, and an inner wall connected to the rib opposite the base.

4. The electric machine of claim 3, wherein each of the plurality of core segments further includes a cutout extending on at least one side of the rib, the cutout forming at least a portion of a respective one of the plurality of slots.

5. The electric machine of claim 1, wherein the plurality of core segments is structured as a stack of tooth-shaped plates connected to one another to form a laminar structure.

6. The electric machine of claim 5, further comprising a plurality of pivot joints, each of the plurality of pivot joins disposed between two respective core segments.

7. The electric machine of claim 6, wherein the plurality of pivot joints is made from a connecting material between features in the tooth-shaped plates.

8. The electric machine of claim 1, the stator is configured of assembly of the plurality of windings onto the plurality of core segments when the plurality of core segments is in an unrolled, open position.

9. The electric machine of claim 1, further comprising a plurality of air gaps extending radially through at least a portion of the core between adjacent segments in the plurality of core segments, the plurality of air gaps being alternatingly disposed in the core with the plurality of slots.

10. The electric machine of claim 1, wherein the core is a rotor core or a stator core.

11. A method for constructing an electric machine, comprising:
providing a core, the core comprising a plurality of core segments arranged adjacent to one another on a generally flat surface in an unrolled condition, wherein each of the plurality of core segments has a generally truncated triangular shape such that wedge-shaped openings are formed between adjacent core segments;
providing a mat of woven conductors, the mat comprising a plurality of bent conductors, each having a straight portion and bent portions at either end of the straight portion;
placing the mat in engaging relation with the unrolled core such that the straight portions of the plurality of bent conductors are disposed in the wedge-shaped openings and the bent portions extend on either side of the unrolled core, the mat and unrolled core defining an unrolled assembly;
rolling the unrolled assembly into a generally cylindrical component; and
securing the generally cylindrical component in a rolled condition such that the straight portions of the plurality of bent conductors are disposed in longitudinal slots formed between adjacent core segments.

12. The method of claim 11, wherein the generally cylindrical component is a stator, the stator forming the longitudinal extending along a longitudinal direction and being equally spaced peripherally around the core, each of the longitudinal slots formed between cutouts in adjacent core segments.

13. The method of claim 11, wherein each of the plurality of core segments has a generally triangular shape that includes a base, a rib disposed adjacent the base, and an inner wall connected to the rib opposite the base.

14. The method of claim 12, wherein each of the plurality of core segments further includes a cutout extending on at least one side of each respective segment, the cutout forming at least a portion of a respective one of the longitudinal slots.

15. The method of claim 11, wherein the plurality of core segments is structured as a stack of tooth-shaped plates connected to one another to form a laminar structure.

16. The method of claim 15, further comprising a plurality of pivot joints, each of the plurality of pivot joins disposed between two respective core segments to preserve alignment between adjacent core segments during the rolling of the unrolled assembly.

17. The method of claim 16, wherein the plurality of pivot joints is made from a connecting material between features in the tooth-shaped plates.

18. The method of claim 11, further comprising providing a plurality of air gaps extending radially through at least a portion of an interface between adjacent core segments, the air gaps being alternatingly disposed with in the core with the longitudinal slots.

19. The method of claim 11, wherein the generally cylindrical component is a rotor core or a stator core of an electrodynamic machine.

20. A stator for a motor, comprising:
a core having a generally cylindrical shape extending along a longitudinal direction, the core comprising a plurality of core segments extending in the longitudinal direction, wherein each of the plurality of core segments is generally triangular and extends over a portion of an outer periphery of the core, each core segment having a base, a rib connected to the base and having at least one cutout, and an inner wall connected to the rib opposite the base,
wherein the bases of the plurality of core segments collectively define an outer cylindrical portion of the core,
wherein the inner walls of the plurality of core segments collectively define an inner rotor bore of the core; and
wherein each cutout at least partially defines one of a plurality of slots extending along the longitudinal direction and being equally spaced peripherally around the core;
a plurality of windings disposed on the core, the plurality of windings including straight portions disposed in the plurality of slots and turn portions extending past at least one axial end of the core along the longitudinal direction; and
a fastening arrangement disposed around an outer periphery of the core, the fastening arrangement securing the plurality of the core segments to one another.
